(19) United States
(12) Patent Application Publication
(10) Pub. No.: US 2019/0380137 A1
(43) Pub. Date: Dec. 12, 2019

(54) JOINT SOURCE CHANNEL TRANSMISSION OVER MMWAVE

(71) Applicant: QUALCOMM Incorporated, San Diego, CA (US)

(72) Inventors: Amichai SANDEROVICH, Atlit (IL); Eran HOF, Haifa (IL); Ran HAY, Rosh Haaein (IL)

(21) Appl. No.: 16/436,499

(22) Filed: Jun. 10, 2019

Related U.S. Application Data
(60) Provisional application No. 62/683,608, filed on Jun. 11, 2018.

(51) Int. Cl. H04W 72/12; H04N 19/176; H04N 19/60; H04W 72/04; H04N 19/513

(52) U.S. Cl. CPC H04W 72/1263; H04N 19/176; H04N 19/513; H04W 72/0453; H04N 19/60

(57) ABSTRACT

Certain aspects of the present disclosure generally relate to wireless communications and, more particularly, systems and methods for compression and transmission of video data using a joint source channel transmission.

### CROSS-REFERENCE TO RELATED APPLICATION(S)

This application claims benefit of and priority to U.S. Provisional Patent Application Ser. No. 62/683,608, filed Jun. 11, 2018, herein incorporated by reference in its entirety for all applicable purposes.

### FIELD OF THE DISCLOSURE

Certain aspects of the present disclosure generally relate to wireless communications and, more particularly, compression and transmission of video data using a joint source channel transmission.

### DESCRIPTION OF RELATED ART

In order to address the issue of increasing bandwidth requirements demanded for wireless communications systems, different schemes are being developed to allow multiple user terminals to communicate with a single access point by sharing the channel resources while achieving high data throughputs.

Certain applications, such as virtual reality (VR) and augmented reality (AR) may demand data rates, for example, in the range of several Gigabits per second. Certain wireless communications standards, such as the Institute of Electrical and Electronics Engineers (IEEE) 802.11 standard, denotes a set of Wireless Local Area Network (WLAN) air interface standards developed by the IEEE 802.11 committee for short-range communications (e.g., tens of meters to a few hundred meters).

Amendments 802.11ad, 802.11ay, and 802.11az to the WLAN standard define the MAC and PHY layers for very high throughput (VHT) in the 60 GHz range. Operations in the 60 GHz band allow the use of smaller antennas as compared to lower frequencies. However, as compared to operating in lower frequencies, radio waves around the 60 GHz band have high atmospheric attenuation and are subject to higher levels of absorption by atmospheric gases, rain, objects, and the like, resulting in higher free space loss. The higher free space loss can be compensated for by using many small antennas, for example arranged in a phased array.

Using a phased array, multiple antennas may be coordinated to form a coherent beam traveling in a desired direction (or beam), referred to as beamforming. An electrical field may be rotated to change this direction. The resulting transmission is polarized based on the electrical field. A receiver may also include antennas which can adapt to match or adapt to changing transmission polarity.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved wireless transmission of video frames.

Certain aspects of the present disclosure provide an apparatus for wireless communications. The apparatus generally includes a first interface configured to obtain one or more video frames. The apparatus also includes a processing system configured to transform the one or more video frames into first components and second components; digitally encode the second components; and generate one or more frames comprising the first components and the digitally encoded second components. The apparatus includes a second interface configured to output the one or more frames for transmission to a wireless node.

Certain aspects of the present disclosure provide an apparatus for wireless communications. The apparatus generally includes a processing system configured to generate a frame including transformed components of one or more video frames; and a second interface configured to output the frame for transmission to a wireless node, wherein outputting the frame for transmission comprises outputting a digital signal indicative of a first portion of the frame and an analog signal indicative of a second portion of the frame.

Certain aspects of the present disclosure provide an apparatus for wireless communications. The apparatus generally includes a first interface configured to obtain one or more frames comprising transformed components of one or more video frames, wherein the transformed components comprise digitally encoded symbols and analog symbols; a processing system configured to decode the transformed components and generate reconstructed video frames based on the decoding; and a second interface configured to output the reconstructed video frames to a video sink device.

Certain aspects of the present disclosure provide an apparatus for wireless communications. The apparatus generally includes a first interface configured to obtain a frame comprising a digital signal and an analog signal; a processing system configured to decode the digital and analog signals and generate reconstructed video frames based on the decoding; a second interface configured to output the reconstructed video frames to a video sink device.

Certain aspects of the present disclosure provide an apparatus for wireless communications. The apparatus generally includes a processing system configured to transform one or more video frames by dividing each of the one or more video frames into a plurality of blocks, applying a first transform to each of the blocks to generate first transformed components, and applying a second transform to at least one of the first transformed components to generate at least one second transformed component. The processing system is also configured to generate one or more frames comprising the first transformed components and the at least one second transformed component. The apparatus also includes an interface configured to output the one or more frames for transmission to a wireless node.

Certain aspects of the present disclosure provide an apparatus for wireless communications. The apparatus generally includes a processing system configured to decode one or more transformed video frames based on multi-stage inverse transforms; and an interface configured to output the decoded one or more video frames to a video sink device.

Certain aspects of the present disclosure provide an apparatus for wireless communications. The apparatus generally includes a processing system configured to transform one or more video frames using a multi-dimensional discrete cosine transform (DCT) and generate one or more frames comprising the transformed one or more video frames. The apparatus also includes an interface configured to output the one or more frames for transmission to a wireless node.

Certain aspects of the present disclosure provide an apparatus for wireless communications. The apparatus generally includes a processing system configured to decode one or more transformed video frames using a multi-dimensional inverse discrete cosine transform (IDCT); and an interface configured to output the decoded one or more video frames to a video sink device.

Aspects of the present disclosure also provide various methods, means, and computer program products corresponding to the apparatuses and operations described above.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 is a diagram illustrating signal propagation in an implementation of phased-array antennas, in accordance with certain aspects of the present disclosure.

FIG. 4 is a diagram of wireless nodes configured to support joint source channel transmissions, in accordance with certain aspects of the present disclosure.

FIG. 5 illustrates example operations for a compression scheme of video frames, in accordance with certain aspects of the present disclosure.

FIG. 5A illustrates example components capable of performing the operations shown in FIG. 5, in accordance with certain aspects of the present disclosure.

FIG. 6 illustrates example operations for decoding the compressed video frames, in accordance with certain aspects of the present disclosure.

FIG. 6A illustrates example components capable of performing the operations shown in FIG. 6, in accordance with certain aspects of the present disclosure.

FIG. 7 illustrates an example PHY frame structure, in accordance with certain aspects of the present disclosure.

FIG. 8 illustrates an example operation for image compression, in accordance with certain aspects of the present disclosure.

FIG. 9 illustrates an example graph of the second moment of the luma components of transformed blocks of an example image, in accordance with certain aspects of the present disclosure.

FIG. 10A illustrates an example graph of channel-usage allocations for first transformed components, in accordance with certain aspects of the present disclosure.

FIG. 10B illustrates an example graph of channel-usage allocations for second transformed components, in accordance with certain aspects of the present disclosure.

FIG. 11 illustrates an example inter-frame compression operation, in accordance with certain aspects of the present disclosure.

FIG. 12 is a diagram illustrating an example transmission operation of compressed video frames, in accordance with certain aspects of the present disclosure.

FIG. 13 is a diagram illustrating an example reception operation of compressed video frames, in accordance with certain aspects of the present disclosure.

FIG. 14 illustrates example operations for compressing video frames, in accordance with certain aspects of the present disclosure.

FIG. 14A illustrates example components capable of performing the operations shown in FIG. 14, in accordance with certain aspects of the present disclosure.

FIG. 15 illustrates example operations for decoding compressed video frames, in accordance with certain aspects of the present disclosure.

FIG. 15A illustrates example components capable of performing the operations shown in FIG. 15, in accordance with certain aspects of the present disclosure.

FIG. 16 illustrates example operations for compressing video frames, in accordance with certain aspects of the present disclosure.

FIG. 16A illustrates example components capable of performing the operations shown in FIG. 16, in accordance with certain aspects of the present disclosure.

FIG. 17 illustrates example operations for decoding compressed video frames, in accordance with certain aspects of the present disclosure.

FIG. 17A illustrates example components capable of performing the operations shown in FIG. 17, in accordance with certain aspects of the present disclosure.

FIG. 18 illustrates example operations for transmitting video frames via a protocol data unit, in accordance with certain aspects of the present disclosure.

FIG. 18A illustrates example components capable of performing the operations shown in FIG. 18, in accordance with certain aspects of the present disclosure.

FIG. 19 illustrates example operations for receiving video frames via a protocol data unit, in accordance with certain aspects of the present disclosure.

FIG. 19A illustrates example components capable of performing the operations shown in FIG. 19, in accordance with certain aspects of the present disclosure.

FIG. 20 illustrates an example frame structure for transmitting video data, in accordance with certain aspects of the present disclosure.

FIG. 21 is a timing diagram of an example operation for transmitting video data, in accordance with certain aspects of the present disclosure.

FIG. 22 is a diagram illustrating an example operation for video frame decoding, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide methods and apparatus for compression and transmission of video data using a joint source channel transmission. For example, the compression and transmission schemes described herein may enable the transmission of low latency video data, such as for AR/VR applications. A wireless node may transform video frames into first components and second components using, for example, a multi-stage transform. The wireless node may digitally encode the second components and generate frames comprising the first components and the digitally encoded second components. The wireless node may transmit, to another wireless node, the digitally encoded second components via a digital signal and the first components via an analog signal without any rate control feedback from the other wireless node. In certain aspects, the present disclosure may provide a medium access control (MAC) format for conveying the analog and digital components of the video frames transmissions.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

### Example Wireless Communication System

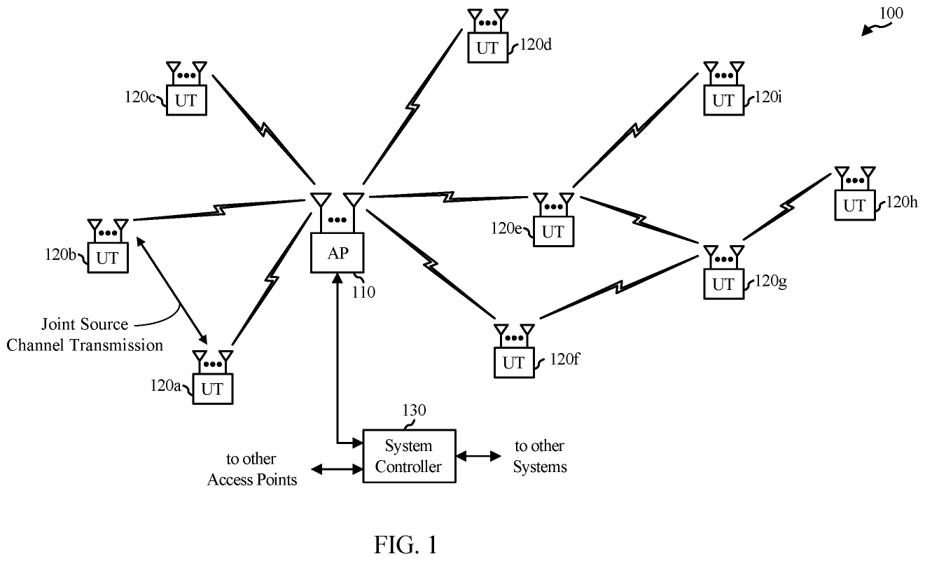

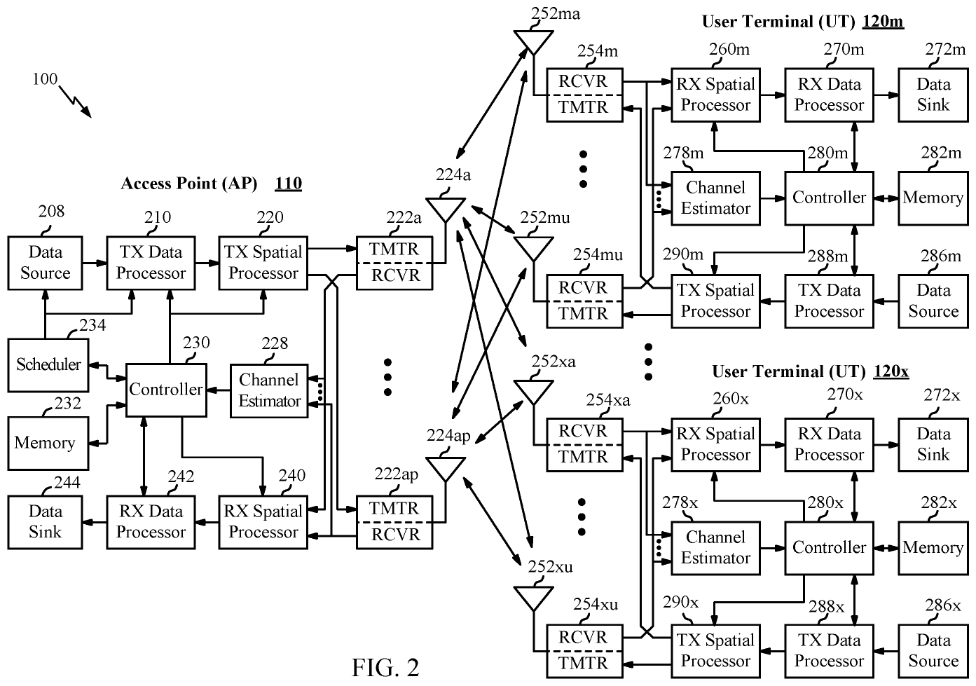

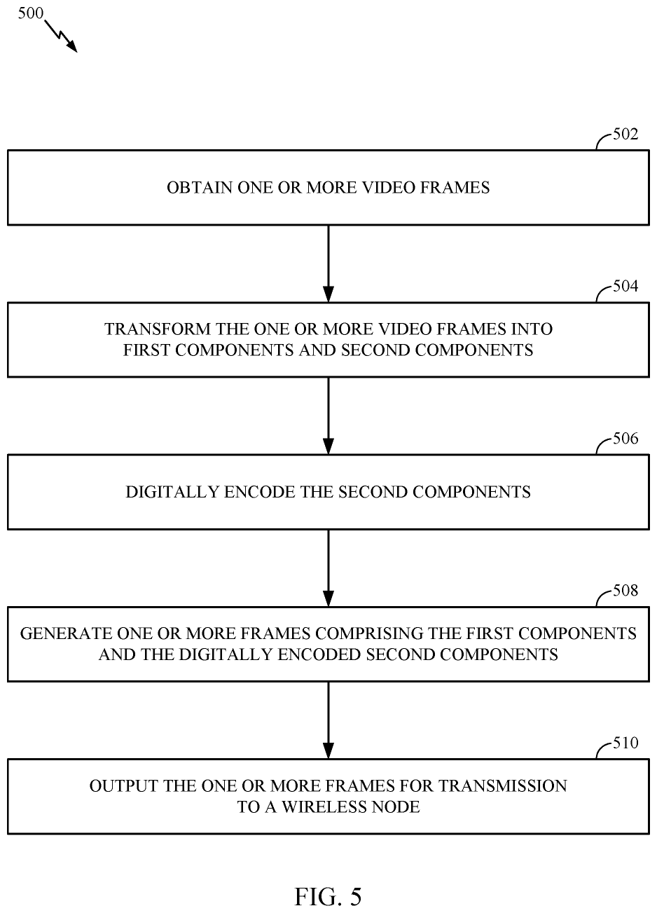

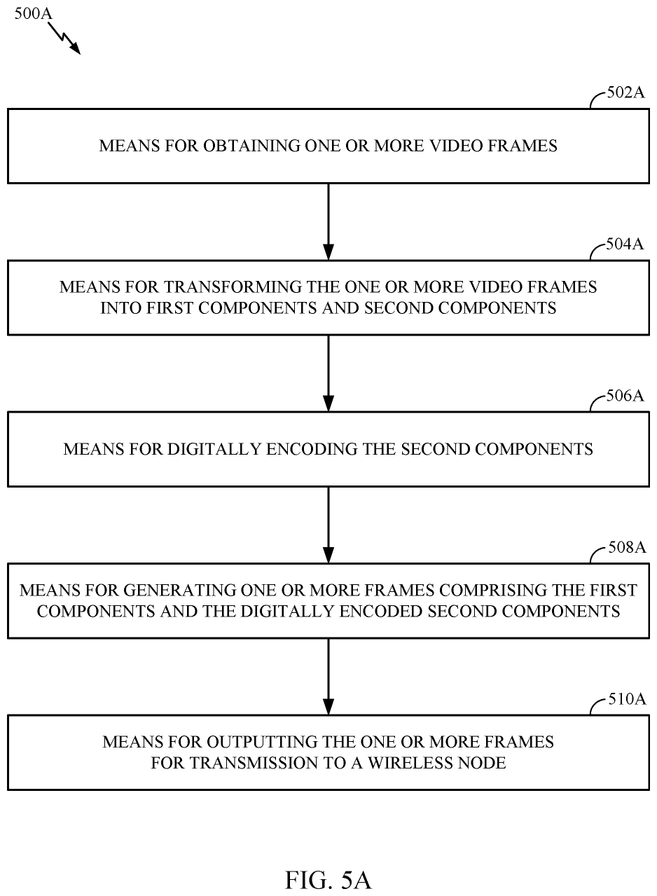

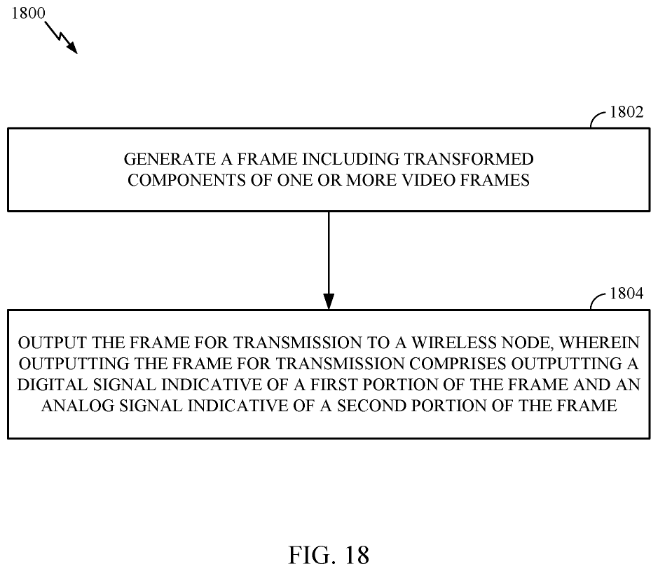

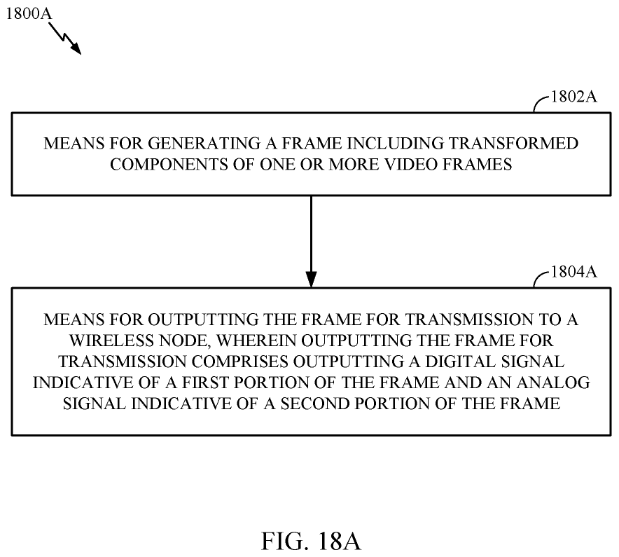

FIG. 1 illustrates a multiple-access multiple-input multiple-output (MIMO) system 100 (e.g., 802.11ad, 802.11ay, 802.11az, LTE, or NR wireless communication systems) with access points 110 and user terminals 120. Certain aspects of the present disclosure relate techniques for compressing and transmitting video data. For example, a user terminal 120a may transform video frames into digital and analog components as further described herein with respect to FIGS. 5-22 and transmit the transformed video frames to the user terminal 120b. The user terminal 120a may compress the video frames using a multi-stage transform as described herein, for example, with respect to the operations illustrated in FIGS. 8 and 11. In certain aspects, the compressed video frames described herein may be transmitted via a protocol data unit (e.g., a PPDU of 802.11ay) using a certain medium access control (MAC) format as further described herein with respect to FIGS. 18-22.

For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≥K≥1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≥1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

FIG. 2 illustrates a block diagram of access point 110 and two user terminals 120m and 120x in MIMO system 100. In certain aspects, the access point 110 may transform video frames into digital and analog components as further described herein with respect to FIGS. 5-22 and transmit the transformed video frames to the user terminal 120m. The access point 110 may compress the video frames using a multi-stage transform as described herein, for example, with respect to the operations illustrated in FIGS. 8 and 11. In certain aspects, the compressed video frames described herein may be transmitted via a protocol data unit (e.g., a PPDU of 802.11ay) using a certain medium access control (MAC) format as further described herein with respect to FIGS. 18-22.

The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. The term communication generally refers to transmitting, receiving, or both. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

Certain standards, such as the IEEE 802.11ay standard, extend wireless communications according to existing standards (e.g., the 802.11ad standard) into the 60 GHz band. Example features to be included in such standards include channel aggregation and Channel-Bonding (CB). In general, channel aggregation utilizes multiple channels that are kept separate, while channel bonding treats the bandwidth of multiple channels as a single (wideband) channel.

As described above, operations in the 60 GHz band may allow the use of smaller antennas as compared to lower frequencies. While radio waves around the 60 GHz band have relatively high atmospheric attenuation, the higher free space loss can be compensated for by using many small antennas, for example arranged in a phased array.

Using a phased array, multiple antennas may be coordinated to form a coherent beam traveling in a desired direction. An electrical field may be rotated to change this direction. The resulting transmission is polarized based on the electrical field. A receiver may also include antennas which can adapt to match or adapt to changing transmission polarity.

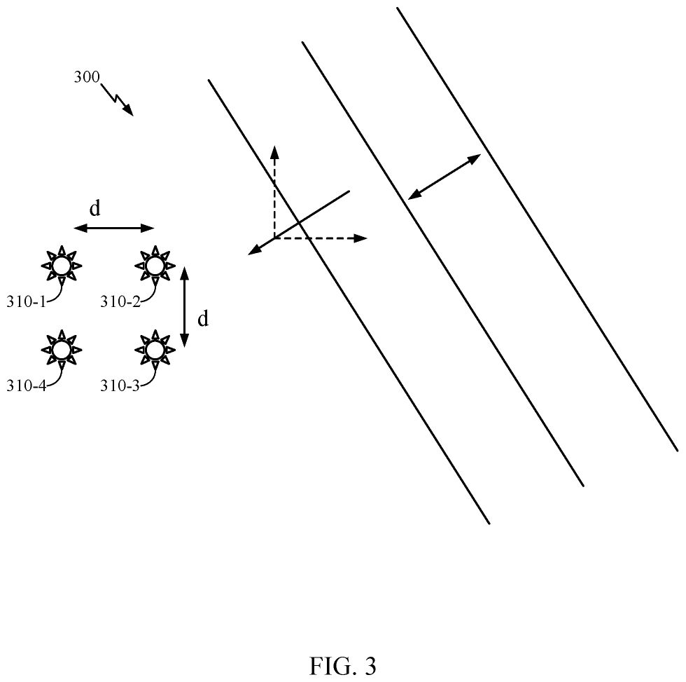

FIG. 3 is a diagram illustrating signal propagation 300 in an implementation of phased-array antennas. Phased array antennas use identical elements 310-1 through 310-4 (hereinafter referred to individually as an element 310 or collectively as elements 310). The direction in which the signal is propagated yields approximately identical gain for each element 310, while the phases of the elements 310 are different. Signals received by the elements are combined into a coherent beam with the correct gain in the desired direction.

In high frequency (e.g., mmWave) communication systems like 60 GHz (e.g., 802.11ad, 802.11ay, and 802.11az), communication is based on beamforming (BF), using phased arrays on both sides for achieving good link. As described above, beamforming (BF) generally refers to a mechanism used by a pair of STAs to adjust transmit and/or receive antenna settings achieve desired link budget for subsequent communication. As will be described in greater detail below, in some cases, a one-dimensional sector may be formed using beamforming.

### Example Joint Source Channel Transmission

Virtual reality video sources (e.g., video frames for left and right eyes) are compressed to a bit-stream of specified rate. The resulting bit-stream may be communicated over standard 60 GHz network devices (e.g. 802.11ad/y). For example, communication takes place from a VR console to a VR head device.

Compressed video requires a highly-reliable bit-pipe (i.e., a constant bit rate (CBR)) in terms of provided rate. In wireless digital communication networks, data rates can vary rapidly, which may happen due to physical medium and network characteristics. This is prominent in 60 GHz medium, for example, where line of sight directional beams are an aspect in providing reliable communications. A drop in the data rate for compressed video sources lead to inevitable frame losses. Therefore, certain schemes for video communications provide a substantial amount of buffering. Two main buffers are used, a data stream buffer (DSB), which is implemented by the decoder-receiver, and bit rate averaging buffer (BRAB), which is implemented by the encoding-transmitter.

Buffering may not be suitable in virtual reality applications where latency is one of the main concerns in terms of user experience, for example, due to VR sickness. As a result, video transmission systems may include complex rate-control techniques to match the compression rate to currently provided bit-pipe rate in real time. These rate-control techniques cannot predict the channel state in the future, and thus a constant backoff from optimal MCS needs to be used. In addition, a constant backoff for the compression rate to avoid buffer overflow is required since an image is not evenly compressed across the image. Some parts of the frame are compressed better than others. All these backoffs significantly degrade the spectral efficiency of the video transmission scheme.

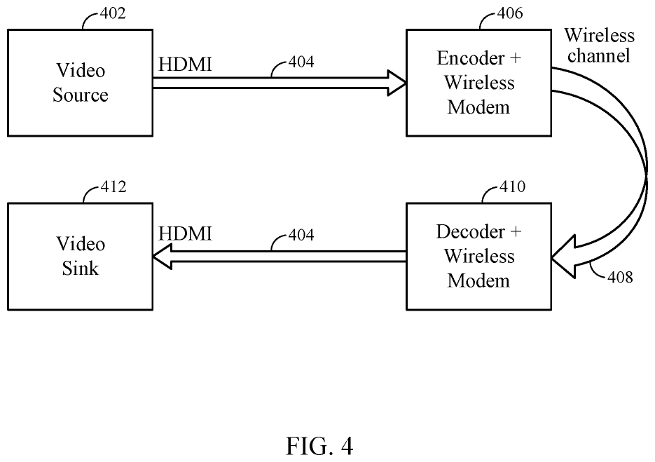

In certain aspects, the compression and transmission scheme described herein enables the transmission of low latency video data, such as for AR/VR applications. For example, FIG. 4 is a diagram of an example compression and transmission scheme, in accordance with certain aspects of the present disclosure. As shown, a video source device 402 (e.g., a VR console) provides video data to an encoder/modem 406 via a bus interface 404 such as High-Definition Multimedia Interface (HDMI®), DisplayPort™, or mobile industry processor interface (MIPI). The encoder/modem 406 compresses the video data according to the compression scheme described herein. The encoder/modem 406 may transmit the compressed video data as an analog signal interleaved with a digital signal via the wireless channel 408. The decoder/modem 410 decodes the compressed video data and provides the reconstructed video data to a video sink device 412 (e.g., a VR headset) via the bus interface 404.

FIG. 5 illustrates example operations 500 for a compression scheme of video frames, in accordance with certain aspects of the present disclosure. The operations 500 may be performed, for example, by a wireless node (e.g, AP 110 or user terminal 120). Operations 500 may be implemented as software components that are executed and run on one or more processors (e.g., controller 230 of FIG. 2). In certain aspects, the transmission and/or reception of signals by the wireless node may be implemented via a bus interface of one or more processors (e.g., controller 230) that obtains and/or outputs signals. Further, the transmission and reception of signals by the wireless node of operations 500 may be enabled, for example, by one or more antennas and/or transmitter/receiver unit(s) (e.g., antenna(s) 224 or transmitter/receiver unit(s) 222 of FIG. 2).

The operations 500 begin, at 502, where the wireless node obtains one or more video frames. At 504, the wireless node transforms the one or more video frames into first components and second components. At 506, the wireless node digitally encodes the second components. At 508, the wireless node generates one or more frames comprising the first components and the digitally encoded second components. At 510, the wireless node outputs the one or more frames for transmission to another wireless node.

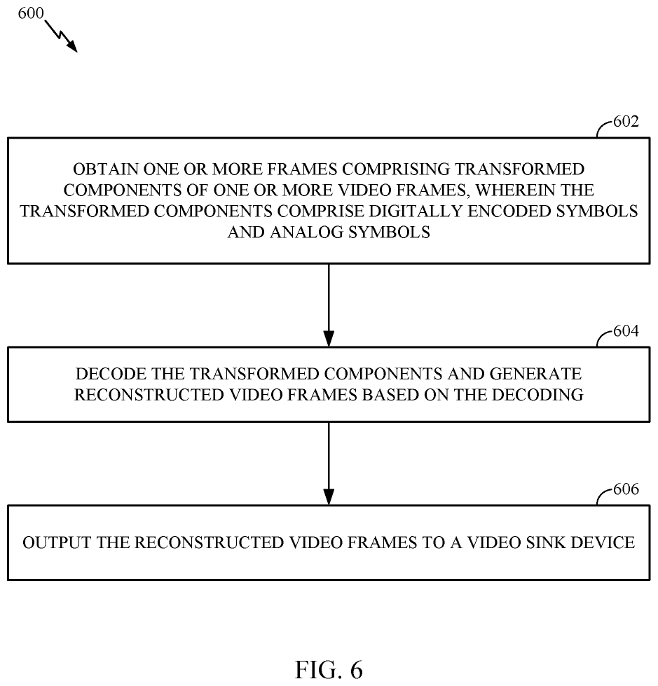

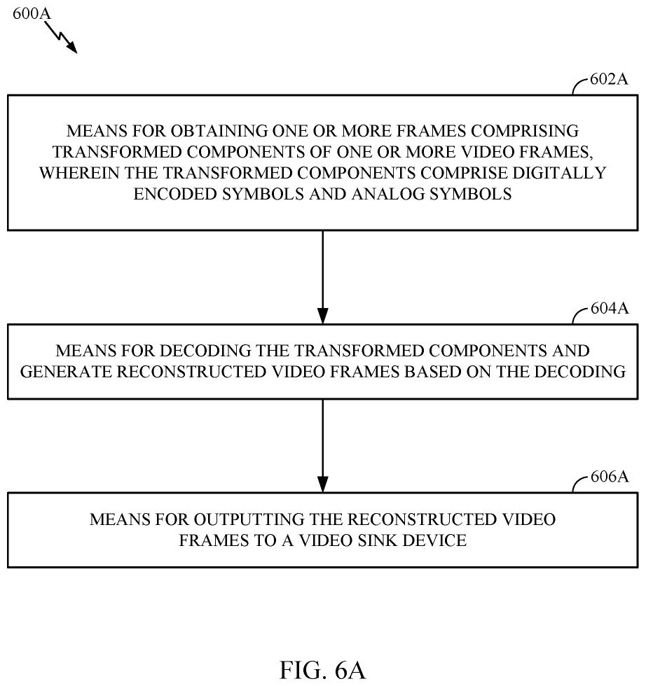

FIG. 6 illustrates example operations 600 for decoding compressed video frames, in accordance with certain aspects of the present disclosure. The operations 600 may be performed, for example, by a wireless node (e.g, AP 110 or user terminal 120). Operations 600 may be implemented as software components that are executed and run on one or more processors (e.g., controller 230 of FIG. 2). In certain aspects, the transmission and/or reception of signals by the wireless node may be implemented via a bus interface of one or more processors (e.g., controller 230) that obtains and/or outputs signals. Further, the transmission and reception of signals by the AP of operations 600 may be enabled, for example, by one or more antennas and/or transmitter/receiver unit(s) (e.g., antenna(s) 224 or transmitter/receiver unit(s) 222 of FIG. 2).

The operations 600 begin, at 602, where the wireless node obtains one or more frames comprising transformed components of one or more video frames, wherein the transformed components comprise digitally encoded symbols and analog symbols. At 604, the wireless node decodes the transformed components and generates reconstructed video frames based on the decoding. At 606, the wireless node outputs the reconstructed video frames to a video sink device.

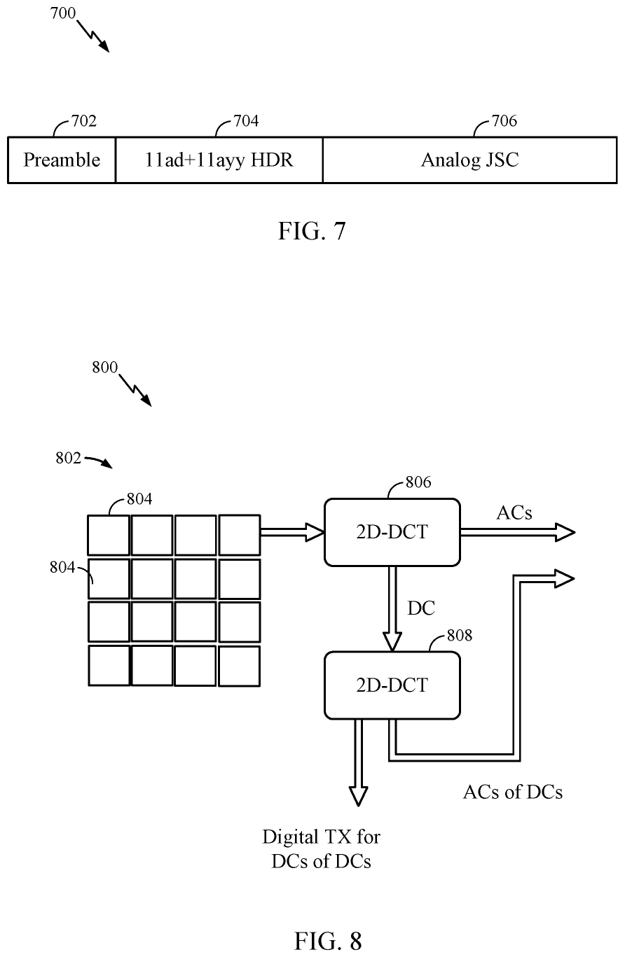

In certain aspects, the compressed video data described herein may be transmitted via a protocol data unit (e.g., a Physical Layer Convergence Protocol (PLCP) Protocol Data Unit (PPDU)). For example, FIG. 7 illustrates an example PHY frame structure for transmitting video data, in accordance with aspects of the present disclosure. As shown, the frame structure comprises a preamble 702, a header 704 (e.g., a physical layer header of protocol data unit such as an 802.11ad or 802.11ay header), and a PLCP Service Data Unit (SDU) 706 interleaved with analog samples as further described herein.

In certain aspects, the video data may be compressed via a single or multi-stage transform operation(s) (e.g., at 504 of FIG. 5). For example, FIG. 8 illustrates example operations 800 for image compression, in accordance with certain aspects of the present disclosure. Although the operations 800 are described with respect to the compression of a single video frame or image, the operations 800 are also applicable to a stream of video frames or images. The operations 800 may also be applied to left-right eye (L/R) compensation schemes and inter-frame schemes as further described herein. That is, when L/R compensations and inter-frame techniques are introduced, these provide different inputs for the same core frame processing operations 800 (in addition to added digital information and multi-focal planes).

The operations 800 for a single video frame 802 is based on multi-stage transforms (shown as two stages of transforms) applied to blocks 804 of the video frame 802. The blocks 804 may have sizes, for example, of 4×4, 8×8, or 16×16 bits. The transforms applied to the blocks may be implemented as a multi-dimensional discrete cosine transform (DCT), such as a two-dimensional DCT, three-dimensional DCT, or a four-dimensional DCT. Another parameter to consider is the number of transform iterations. As illustrated in FIG. 8, the operations 800 applies two stages of the 2D-DCT. Tests have shown that a single stage is sufficient for the channel at hand, such as 3.52 GHz Bandwidth, at 60 Ghz band, used in 50% utilization. Two stages on the other hand provide appealing results. It should be appreciated that multiple transform stages may also be applied, such as three or four stages of transforms.

The operations 800 begin by dividing the frame 802 into blocks 804. For example, a frame F may be implemented as a matrix of size V×H×3, where H is the horizontal resolution in pixels and V is the vertical resolution in pixels (for 4K H=3840 pixels and V=2160 pixels). The third dimension is the color components, e.g., RGB or YCbCr. Each matrix is an integer (typically 8-10 bits). A component represents a set of pixels of the video corresponding to the video frame. For example, a component may be coefficients of a transform representing a block of pixels of a video frame. Each color component is treated separately. For latency, performance information may be sent in an interleaved manner. That is, all color components of a certain super block may be transmitted before the components of the next super block. The frame F is sliced into blocks, B₁, B₂, . . . B_{M}, and each of these block is of size V_{B}×H_{B}×3, where V_{B} and H_{B} are the vertical and horizontal dimensions of the block (e.g., V_{B}=H_{B}=8). The third component is a color component. The operations may apply multi-stage transform to all color components (though different parameters may be used, e.g., number of transformed components applied to a second transform stage). A block B of size V_{B}×H_{B} (of a certain color component) is transformed via a first stage of a transform 806 (e.g., a 2D-DCT) to provide a block of transformed values TB=2D-DCT(B). The transformed block TB is of the same dimensions, V_{B}×H_{B}. The components of TB are given as TB(k, l), where 0<=k<V_{B}, 0<=l<H_{B}. A direct current (DC) component (i.e., DC coefficients) may be used to indicate the average over the entire input. The DC component may be, for example, TB(0,0), and the remaining components may be alternating current (AC) components (i.e., AC coefficients). The DC component of V_{B}×H_{B} blocks are aggregated for the second stage of the transform 808 (e.g., a 2-D DCT). That is, the multi-stage transforms may be implemented as multiple stages of a plurality of transforms, wherein the results of a previous or initial transform stage are applied to the transform of the next stage. In cases where V_{B} and H_{B} are rather small (8×8 pixels), the impact on latency for two stages is negligible and of zero concern. The second stage transform 808 is separated into DC values and AC values, referred to herein as DC-of-DCs and ACs-of-DCs as noted in FIG. 8.

In certain aspects, the operations 800 may be performed in a narrow manner, for example, where only the component TB(0,0) of the second stage transform 808 is regarded as the DC-of-DCs, or in a generalized manner, where several components of the second stage transform 808 are regarded as DCs-of-DCs and the remaining components are considered the ACs-of-DCs. For example, the four components TB(0,0), TB(0,1), TB(1,0) and TB(1,1) may be treated as the DCs-of-DCs and the remaining components may be treated as ACs-of-DCs. In any case, the number of transformed components treated as the DCs-of-DCs is a parameter that may vary. The number DCs-of-DCs may be kept small enough so that a given rate of digital information is maintained.

The DCs-of-DCs may be encoded digitally and transmitted via a digital signal. In certain aspects, a loss-less compression scheme may be applied to the DC-of-DCs values. For aspects, the DCs-of-DCs may use differential encoding for ‘DC-like’ values of a transformed image that is followed by an arithmetic-like encoder. Since the values of the DCs-of-DCs are already a result of a second transformation and as long as the number of DCs-of-DCs is kept small, e.g. 1-4, there is no substantial gain achieved from adding this complexity.

In certain aspects, the ACs (e.g., ACs of the first stage transformation and the ACs-of-DCs of the second stage transformation) may be assigned to channels based on a histogram of the video frames. Consider a block of transformed values, TB. TB can be a block of transformed values from every transform stage. In the example at hand, TB can be either the results of the first stage transform or the second stage transform. Given a certain ordering of the block TB(kₘ, lₘ) where 0<=kₘ<V_{B}, 0<=lₘ<H_{B}, 0<=m<N_{AC} where N_{AC} is the number of AC values and the pairs (kₘ, lₘ) lists all the AC values (in a certain order, e.g., zig-zag scan). ACₘ denotes the m-th AC value TB(kₘ, lₘ) in TB. Each AC value ACₘ is assigned a number of channel usages 0<=CUₘ. Some AC values may be assigned with several channels usages and some may not be transmitted at all (0 usages). The assignment of channel usages may correspond to the content of the AC values in general. That is, the general statistics of the values and not the specific value of a certain block. As an example, channel usage may be based on a variant of linear coding for vector channels. A linear operation on a source vector under minimum linear mean square error estimation at the receiver may be used to allocate the channel usage. A certain setting of the channel-usage allocation parameters, CUₘ, 0<=m, may be used under minimum linear mean square error estimation at the receiver. Channel-usage allocations are provided under a constrained sum of channel-usage allocation per block. This constraint is set in order to provide a certain frame rate under a given channel bandwidth. Specifically, the optimization problem is given by:

| | |
|---|---|
| min | sumₘ LMMSE(ACₘ) |
| subject to | sumₘ CUₘ = CU |

where LMMSE(ACₘ) is the linear minimum mean square error for the estimation of the AC value ACₘ and CU is the total number of channel usages allocated per transformed block. A certain statistics knowledge of the AC values is assumed. The AC values are assumed to be of zero mean and a certain second movement values. These values are either set in an off-line manner or via a slow control process monitoring the stream of frames. This process may be updated in a slow fashion, e.g. via the overall control processing module. Given, an update for the statistical values, an efficient solution for the optimization problem is provided.

Given a certain channel-usage allocation setting, CUₘ, for a given AC values, ACₘ, of a certain block, these values may be transmitted in an analog fashion. In a given channel usage, I,Q values for transmission as set according to the linear mapping I=Aₘ ACₘ, Q=Aₘ′ ACₘ′ where m, m′ are the next pair of AC values for transmission. Aₘ and Aₘ′ are the linear gains applied for the pair of AC value at hand. All these transmissions take place during the analog joint source transmission interval of the protocol data unit as depicted in FIG. 7.

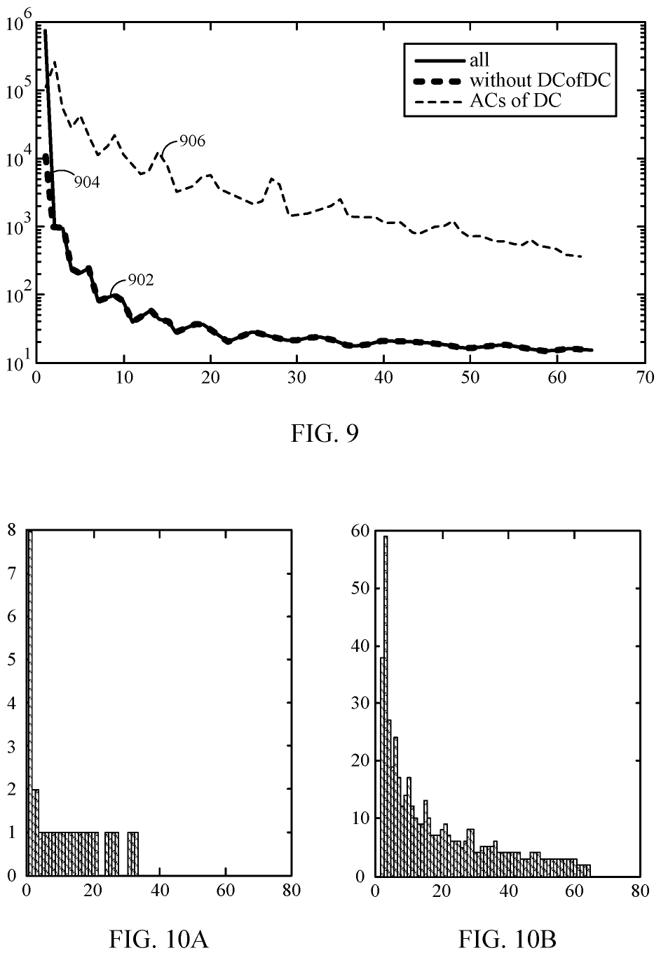

Suppose a 2D-DCT transform of blocks of size 8×8 is applied to YCbCr color components of an example image. FIG. 9 illustrates an example graph of the second moment of the luma components of transformed blocks of the example image, in accordance with certain aspects of the present disclosure. The solid curve 902 corresponds to a single transformation. Note the extremely high values of the curve 902. Providing efficient and clean estimation of the DC and lower AC components for such a high value of second moments is extremely problematic. The dashed curve 904 corresponds to the same components neglecting the DC component of the first transform. The curve 906 for the ACs of DC (except the first which is the DC of the DCs) are moderate corresponding to the second moment of the DC of the first transform. This allows a feasible solution of the channel-usage allocation.

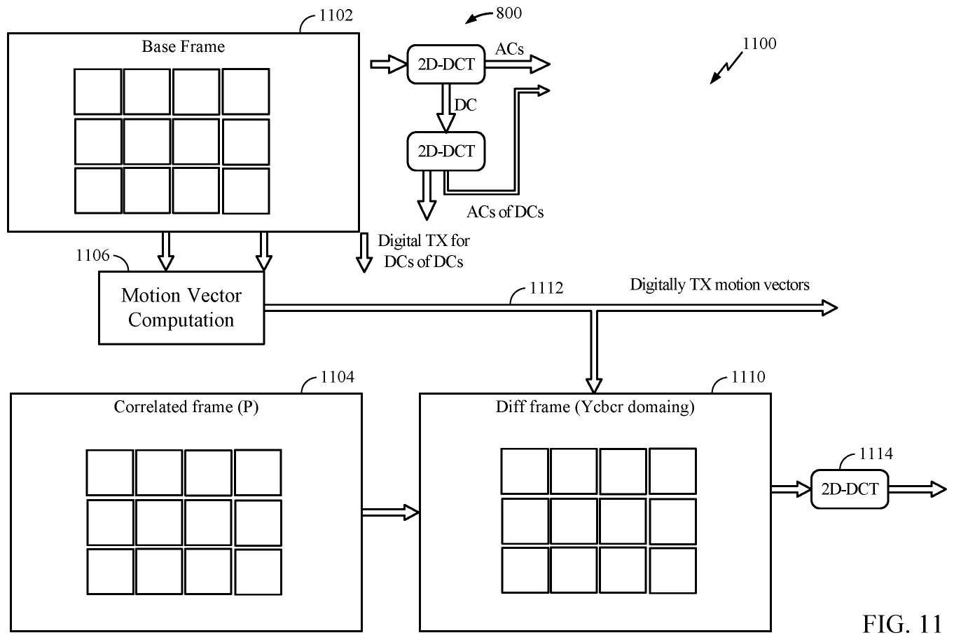

FIGS. 10A and 10B illustrate the results of channel-usage allocations for the Y components of an example image, in accordance with certain aspects of the present disclosure. FIG. 10A shows a plot of an example channel-usage allocation for AC components, and FIG. 10B shows an example channel-usage allocation for ACs-of-DCs. Note that these are aggregated over 8×8 blocks, hence more channels may be allocated for a single ACs-of-DCs block transform. Similar solution may be provided for the Cb and Cr color components. Assuming 50% utilization of 3.52 GHz bandwidth used for analog-like transmission (the interval noted as Analog JSC of the PPDU in FIG. 7), the expected estimation quality (assuming that all transmitted values are random variables of second moments as in FIG. 9) may be computed.

In certain aspects, the channel-usage allocation may be determined for a portion of at least one of first components (e.g., transformed analog symbols, such as ACs or ACs of DCs) or second components (e.g., transformed digital symbols, such as DC(s) of DCs) based on at least one of weights or a histogram of the video frames (e.g., FIG. 9). For example, the histogram of the video frames may be implemented as a histogram of certain components of the video frames, such as second moment transform coefficients (FIG. 9). For aspects, the determination of the channel-usage allocation may be done for each coefficient of the transform. The determination of the channel-usage allocations may be based on the weights identified in the histogram. The channel-usage allocations may be based on at least one of luma components or chroma components of the histogram. For aspects, the determination of the channel-usage allocations is based on at least one of a transmit power of an antenna or image quality at a wireless node. In certain situations, the determination of channel-usage allocations comprises determining that no channel-usage allocations are to be allocated to a second portion of at least one of the first components or the second components based on at least one of the weights or the histogram of the one or more video frames. For aspects, frames may be generated by generating multiple repetitions of a third portion of at least one of the first components or the second components based on the channel-usage allocations.

In certain aspects, the channel-usage allocations may be based on a point of interest corresponding to the video frames. That is, the point of interest may be a block of pixels or portion of the video frames on which the user will focus, and to enhance the user's experience, the point of interest may, for example, benefit from additional channel-usage allocations. The wireless node of operations 500 may determine the point of interest or the video source may provide an indication of the point of interest. The wireless node may also output an indication of the channel allocations for transmission. For other aspects, the channel-usage allocation may be predetermined, and the wireless node of operations 500 may output the frames according to the predetermined channel-usage allocation.

In certain aspects, the video frames may be transformed without rate control, which may enable little or no frame buffering and/or no frame drops. Rate control provides the knowledge of the SNR drop to provide different and better choices of channel allocation of AC values to number of channel usages considering the current 5 dB SNR at the receiver. As explained, one of the greatest advantages of the compression scheme described herein is that rate control is of no importance.

The multi-stage transform at the transmitter may continue using a channel usage allocation based on, for example, 10 dB SNR and operate without regard to the actual SNR values seen at the receiver. In that case the transmitter follows the channel usage selection operation described herein assuming 10 dB SNR at the receiver even if the actual channel SNR is different, for example, 5 dB SNR. In a sharp contrast, if certain schemes are operated in this fashion, an inevitable frame drop accrues. If frame drops are to be avoided, inevitable latency is introduced (due to buffering measures). So certain schemes not only must apply rate control schemes, in the case of SNR drop either frame (or part of the frame) is dropped. That is, the part transmitted assuming bit-pipe of high rate (high SNR) while received at low SNR. These bits cannot be decoded reliably and results in an inevitable drop at the receiver. Or alternatively, high latency due to buffering which is also highly problematic for VR applications.

In certain aspects, the transmission scheme may be operated in an inter-frame fashion. For example, FIG. 11 illustrates an example operation for inter-frame compression, in accordance with certain aspects of the present disclosure. Motion-compensation techniques may be applied to a frame sequence to provide frame-diffs between left and right eye images in addition to motion vectors. Motion vectors generally refer to vectors corresponding to the motion of objects represented by the video frames. The motion vectors may be transmitted digitally, the same as the DCs-of-DCs. The frame-diffs may be compressed by applying the same transforms followed by an analog-like transmission similar to the single frame operation illustrated in FIG. 8. In certain aspects, the compression of the frame-diffs may be found only in the setting of certain parameters (off-line), such as the number of stages of transforms taken and settings for the channel allocations per AC values.

As illustrated in FIG. 11, two consecutive frames 1102, 1104 may be processed. The first frame is called the base frame 1102 and may be processed using the intraframe algorithm previously discussed, for example, as illustrated in FIG. 8. The second frame is a correlated (P) frame 1104 (i.e., a predictive frame) and is processed using a motion vector computation module 1106 to provide a diff frame 1110 and motion vectors 1112. The motion vectors may be, for example, a two-dimensional vector used for inter prediction that provides an offset from the coordinates in a decoded picture to the coordinates in a reference picture. The correlated (P) frame may be, for example, a forward predicted frame of the base frame 1102 reconstructed based on the motion vectors of the base frame 1102. The diff frame may include difference information indicative of the difference between the correlated (P) frame and the base frame. The motion vectors correspond to blocks in a first video frame based on positions of the blocks in a second video frame. The motion vectors 1112 may be digitally transmitted, while the diff frame 1110 is processed. The motion vectors 1112 may be compressed or encoded using, for example, a loss-less compression scheme. For this example depicted in FIG. 11, a single stage of the 2D-DCT transform 1114 is applied to the diff frame 1110. A single stage is suitable for interframe processing of the correlated frame 1104 as the DC content of the diff frame 1110 is much lower than in a base frame 1102.

Channel-usage allocations may also be determined for the diff frame 1114 as previously described herein. As an example, one or more first channel-usage allocations for first and second components (e.g., ACs, ACs of DCs, and DCs of DCs of base frame) and one or more second channel-usage allocations for the diff frame may be determined. The first channel allocations may be different than the second channel allocations. The wireless node of operations 500 may output an indication of the one or more first channel-usage allocations and the one or more second channel-usage allocations. For other aspects, the channel-usage allocation may be predetermined, and the wireless node of operations 500 may output the frames according to the predetermined channel-usage allocation.

At the receiver, motion vectors are applied to the reconstructed base frame, then the estimated analog-like transmitted AC values of the diff frame are added to provide a reconstructed P frame. The major gain in utilizing this interframe algorithm is in power/utilization gain. As the diff frame can be reconstructed with a substantial less usage of the communication channel, this enables a substantial power gain for the compression/transmission scheme. Apart from individual power gain, this improvement may enable the network to make additional transmissions to devices in the network. The lower eigenvalues content of the diff frame can be further utilized in providing enhanced improvement to the base frame by continuing to send additional channel usages for the AC values of the original frame. This fact is of great importance in the case where motion is limited in a time-interval of interest.

In certain aspects, a motion vector operation may be applied for left/right images in VR/AR applications. As the communication is tailored for VR applications, where two frames for left and right eyes are transmitted simultaneously, the motion vector may be determined for these frames and then the multi-stage transform and analog-like transmission for the two left/right eye frames may be applied. That is, predictive frames corresponding to an eye of a user may be generated based on a portion of one or more video frames corresponding to another eye of the user. For example, with respect to the operation illustrated in FIG. 11, the base frame 1102 may be treated as the left eye and the correlated frame 1104 may be treated as the right eye or vice versa. Of course, part of left and part of right may be considered and also switching over time between left and right matching to base and correlated frames in order to average the performance.

In certain aspects, the predictive compression may be applied to focal planes of a user. That is, predictive frames corresponding to a focal plane of a user may be generated based on a portion of base frames corresponding to another focal plane of the user. The wireless node may generate difference information (a diff frame) indicative of a difference between the one or more predictive frames and the one or more video frames. The frames for transmission, for example at 510, may include an indication of the difference information (e.g., a DCT of the diff frame as illustrated in FIG. 11).

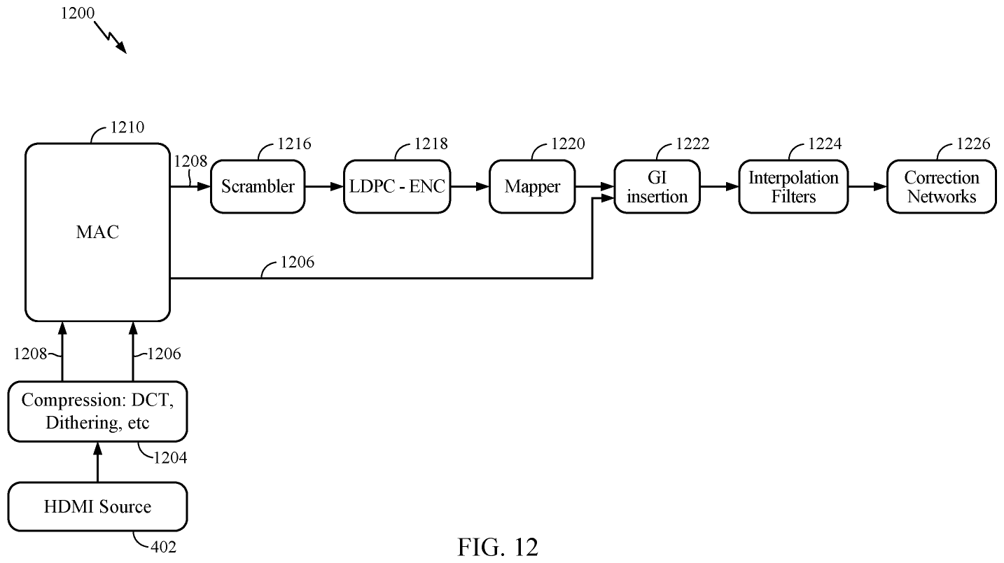

In certain aspects, the compression and encoding may be implemented using a modem of a wireless node (e.g., a modem supporting 802.11, 802.11ay, 802.11ad, mmWave, or 60 GHz unlicensed band applications, transmitter unit 222). FIG. 12 is a diagram illustrating an example transmission operation of compressed video frames, in accordance with certain aspects of the present disclosure. The compression operations 1204 generate two sets of transformed components, first components 1206 and second components 1208, which make up a MAC frame 1210. The first components 1206 may include the ACs and ACs of DCs and are transmitted as analog symbols via one or more channels. One or more of the analog symbols may be outputted for transmission via a single carrier. The modem may apply an analog coding scheme to the first components 1206 via non-linear iterative mapping based on one or more channel-usage allocations. The second components 1208 may include the DCs of DCs and transmitted as digital symbols. The second components are digitally encoded via a scrambler, 1216, low-density parity-check (LDPC) 1218, and a mapper 1220.

The transmission of these signals may take place over a standard PPDU of 802.11 ay. The modulated signals in 802.11 ay are transmitted in blocks, where each block is surrounded by guard interval (GI) sequences (e.g., pilot sequences) that are used for tracking (correcting shifts in phase and frequency) and equalizing at the receiver. This operation is also maintained in the proposed scheme. As shown in FIG. 12, LDPC and mapper are bypassed, and the analog signals (the first components 1206) are grouped in frequency domain equalization (FDE) blocks and then the GI is inserted into each block at 1222. The frame may also undergo interpolation filters 1224 and correction networks 1226. The resulting PHY frame format is changed accordingly. In certain aspects, the transforming of the one or more video frames may include applying dithering and using a pseudo-random sequence to generate the first components of the one or more frames. This may enable the removal of non-random imperfections such a wireless LO leakage and encryption of pixels to prevent external spoofing.

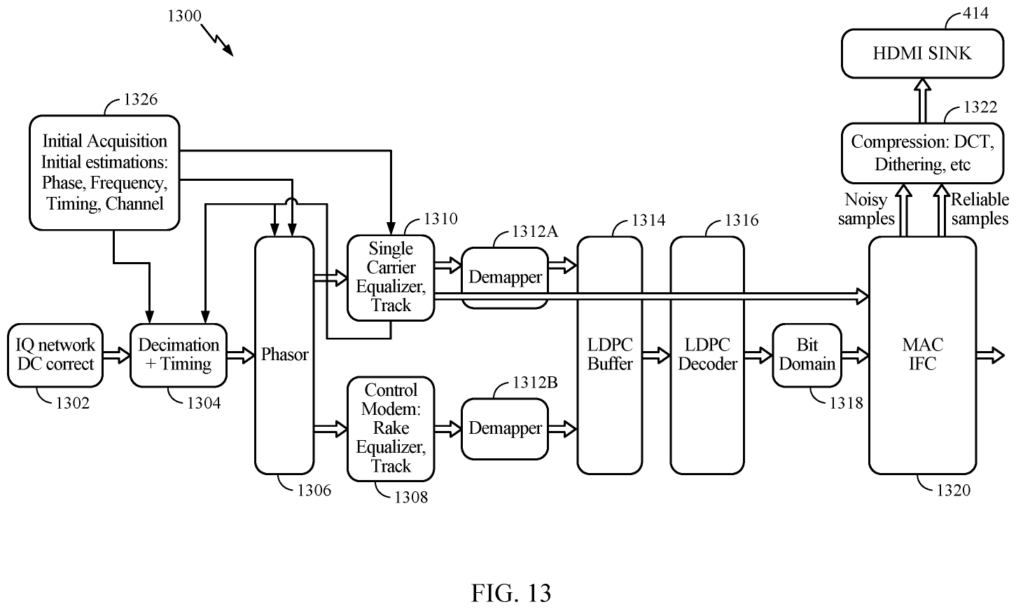

FIG. 13 is a diagram illustrating an example reception operation of compressed video frames, in accordance with certain aspects of the present disclosure. As shown, the receiver may perform DC offset corrections 1302, decimation and timing operations 1304, frequency and phase corrections via a phasor 1306, based on initial estimations 1326. In the case of the analog signals, the single carrier equalizer 1310 outputs are bypassed into the extended MAC interface 1320, bypassing the digital decoding operations such as the demapper 1312A, 1312B, the LDPC buffer 1314, the LDPC decoder 1316, and the bit domain module 1318. This way, the changes to the PHY subsystem are minimal, and the analog signals enjoy all the synchronization benefits of the modem, such as equalization, tracking and correction of phase, timing, frequency and amplitude, duration and CCA protection, multi-user and every additional property of the 802.11 ay network standard feature at hand. The MAC interface 1320 may pass the analog and digital signals to the decoder 1322. The decoder 1322 may decode the transformed video frames using a multi-dimensional inverse DCT and generate reconstructed video frames based on the decoding. The decoder 1322 may output the reconstructed video frames to a video sink (414).

For aspects, the receiver may determine synchronization information based on a time at which a PPDU frame is obtained, and the decoding of the digital and analog signals is based on the synchronization information. generate the one or more frames via a successive refinement operation performed based on at least two previous frame transmissions using different channel-usage allocations.

In certain aspects, the receiver may generate one or more frames (e.g., PPDU frames) via a successive refinement operation performed based on at least two previous frame transmissions using different channel-usage allocations.

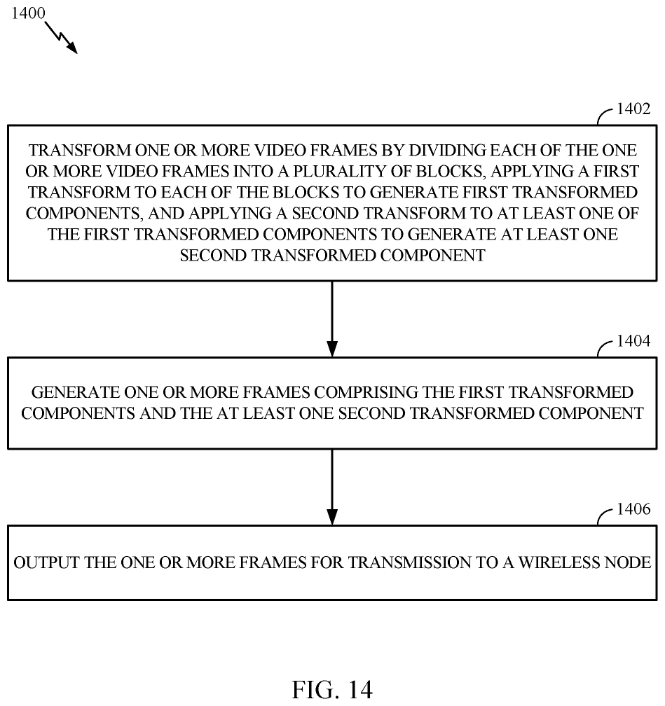

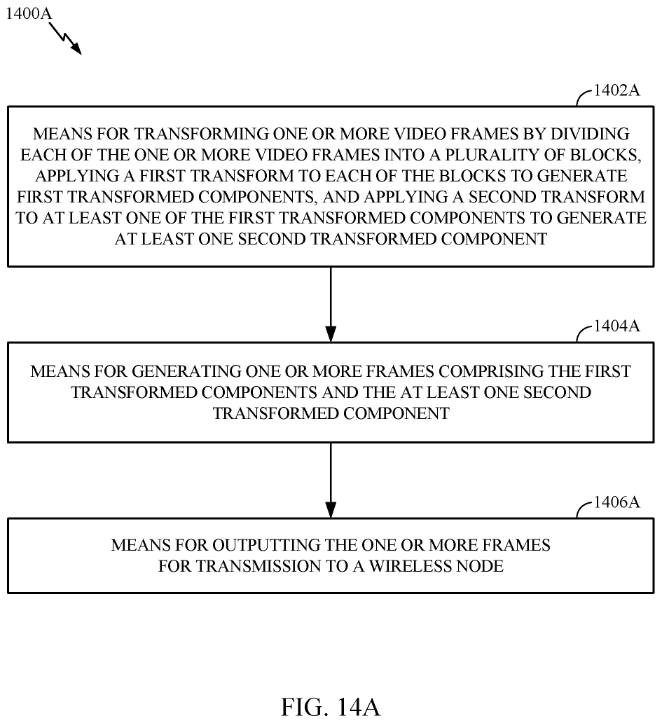

FIGS. 14-18 illustrate example operations for video frame compression and operations for decoding compressed video frames, in accordance with certain aspects of the present disclosure. FIG. 14 illustrates example operations 1400 for compressing video frames, in accordance with certain aspects of the present disclosure. The operations 1400 may be performed, for example, by a wireless node (e.g, AP 110 or user terminal 120). The operations 1400 begin, at 1402, where the wireless node transforms one or more video frames by dividing each of the one or more video frames into a plurality of blocks, applying a first transform to each of the blocks to generate first transformed components, and applying a second transform to at least one of the first transformed components to generate at least one second transformed component. At 1404, the wireless node generates one or more frames comprising the first transformed components and the at least one second transformed component. At 1406, the wireless node outputs the one or more frames for transmission to another wireless node.

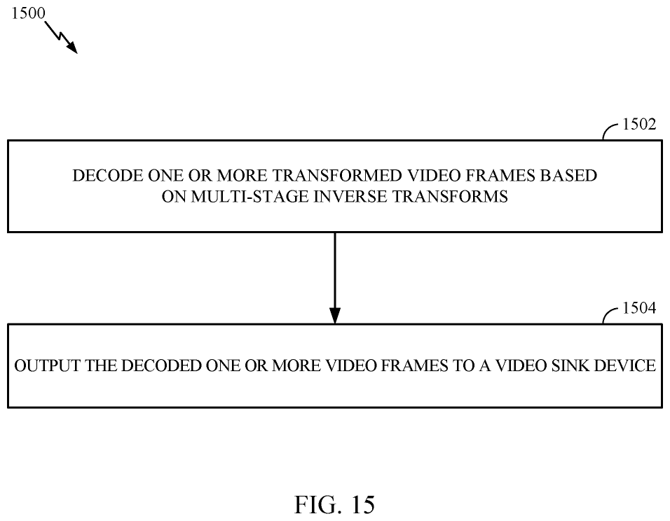

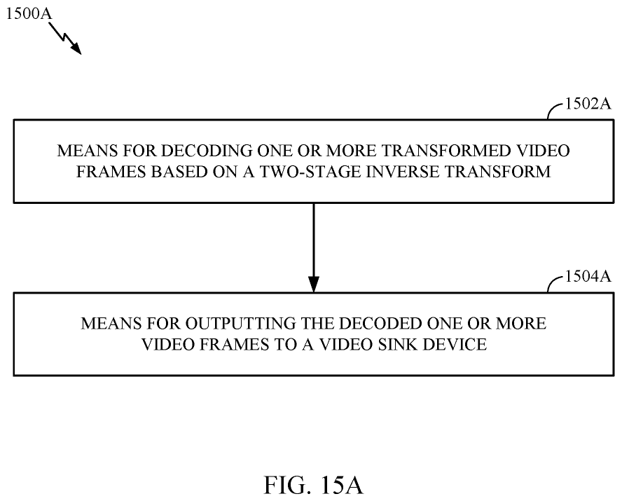

FIG. 15 illustrates example operations 1500 for decoding compressed video frames, in accordance with certain aspects of the present disclosure. The operations 1500 may be performed, for example, by a wireless node (e.g, AP 110 or user terminal 120). The operations 1500 begin, at 1502, where wireless node decodes one or more transformed video frames based on multi-stage inverse transforms. At 1504, the wireless node output the decoded one or more video frames to a video sink device.

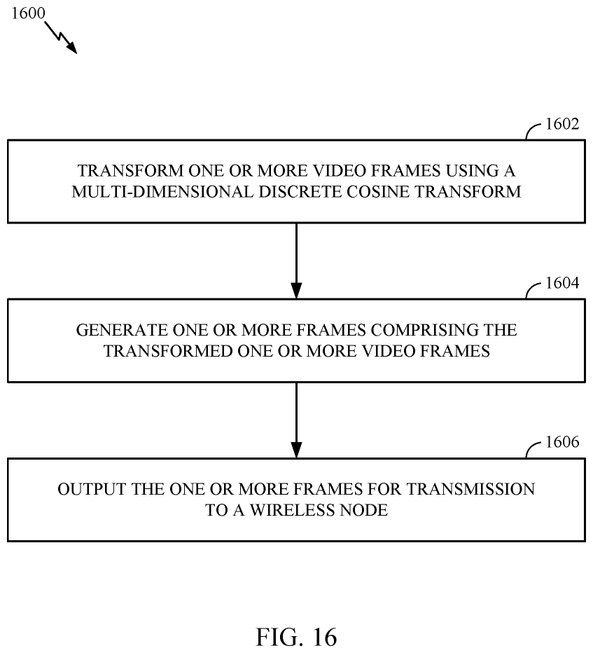

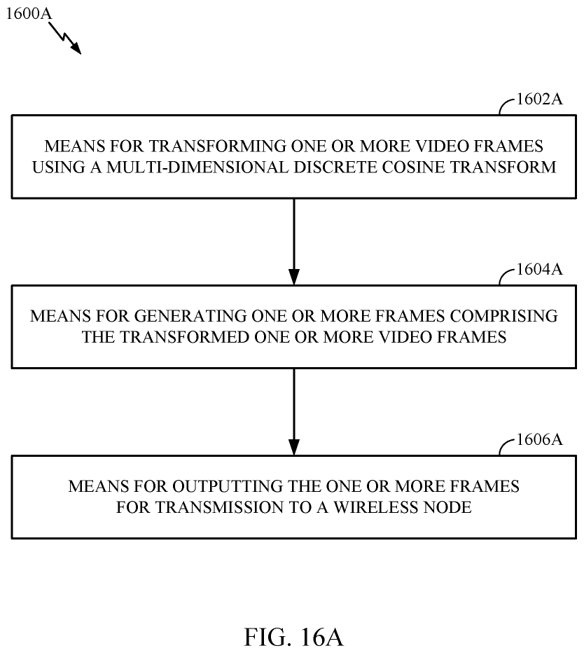

FIG. 16 illustrates example operations 1600 for compressing video frames, in accordance with certain aspects of the present disclosure. The operations 1600 may be performed, for example, by a wireless node (e.g, AP 110 or user terminal 120). The operations 1600 begin, at 1602, where wireless node transforms one or more video frames using a multi-dimensional discrete cosine transform (DCT). At 1604, the wireless node generates one or more frames comprising the transformed one or more video frames. At 1606, the wireless node outputs the one or more frames for transmission to another wireless node.

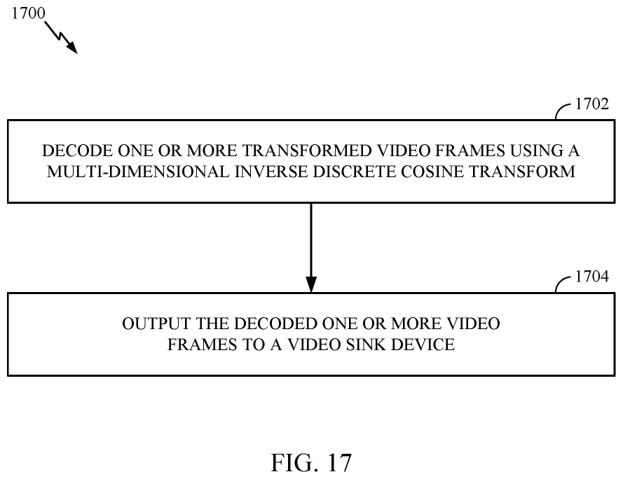

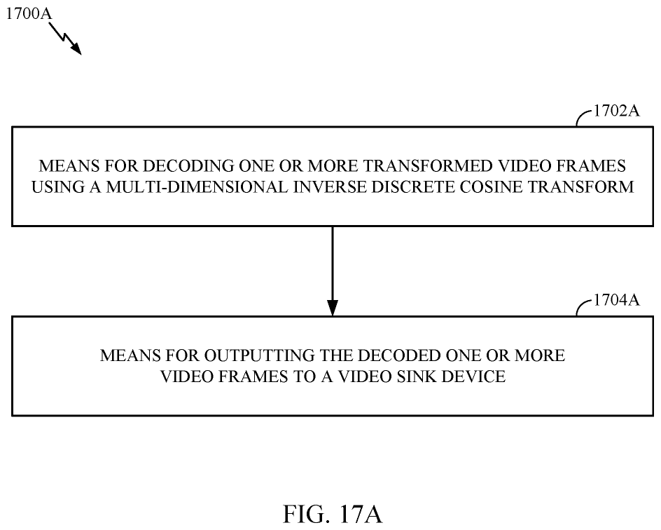

FIG. 17 illustrates example operations 1700 for decoding compressed video frames, in accordance with certain aspects of the present disclosure. The operations 1700 may be performed, for example, by a wireless node (e.g, AP 110 or user terminal 120). The operations 1700 begin, at 1702, where the wireless node decodes one or more transformed video frames using a multi-dimensional inverse discrete cosine transform. At 1704, the wireless node outputs the decoded one or more video frames to a video sink device.

### Example Medium Access Control for Joint Source Channel Transmission

The compressed video frames described herein may be transmitted via a protocol data unit (e.g., a PPDU of 802.11ay) using a certain medium access control (MAC) format.

FIG. 18 illustrates example operations 1800 for transmitting video frames via a PDU, in accordance with certain aspects of the present disclosure. The operations 1800 may be performed, for example, by a wireless node (e.g, AP 110 or user terminal 120). Operations 1800 may be implemented as software components that are executed and run on one or more processors (e.g., controller 230 of FIG. 2). In certain aspects, the transmission and/or reception of signals by the wireless node may be implemented via a bus interface of one or more processors (e.g., controller 230) that obtains and/or outputs signals. Further, the transmission and reception of signals by the wireless node of operations 1800 may be enabled, for example, by one or more antennas and/or transmitter/receiver unit(s) (e.g., antenna(s) 224 or transmitter/receiver unit(s) 222 of FIG. 2).

The operations 1800 begin, at 1802, where the wireless node generates a frame including transformed components of one or more video frames. At 1804, the wireless node outputs the frame for transmission to another wireless node, wherein outputting the frame for transmission comprises outputting a digital signal indicative of a first portion of the frame and an analog signal indicative of a second portion of the frame.

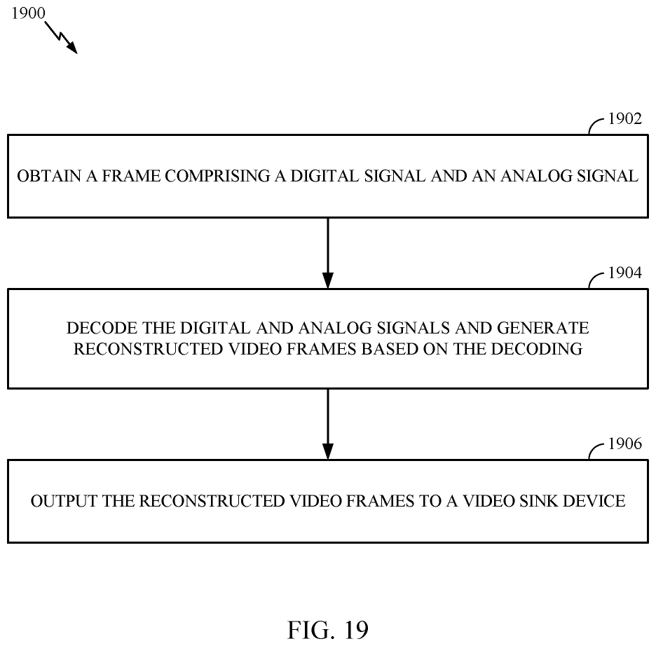

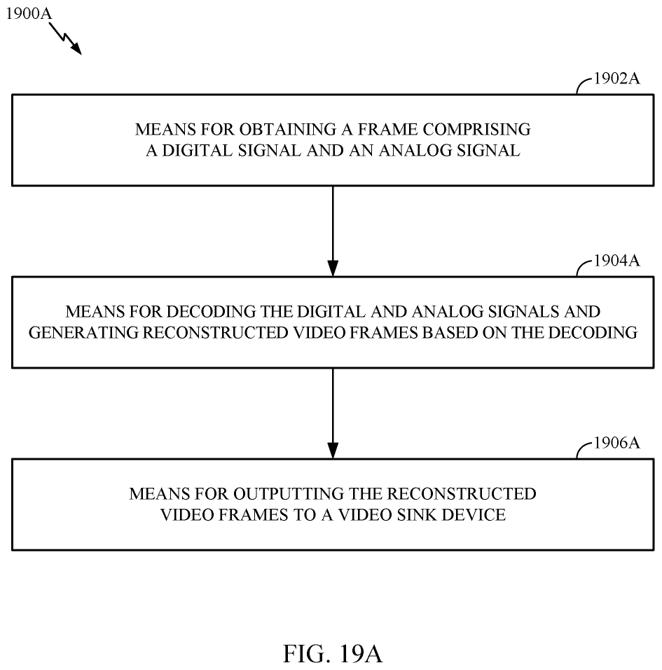

FIG. 19 illustrates example operations 1900 for receiving the video frames, in accordance with certain aspects of the present disclosure. The operations 1900 may be performed, for example, by a wireless node (e.g, AP 110 or user terminal 120). Operations 1900 may be implemented as software components that are executed and run on one or more processors (e.g., controller 230 of FIG. 2). In certain aspects, the transmission and/or reception of signals by the wireless node may be implemented via a bus interface of one or more processors (e.g., controller 230) that obtains and/or outputs signals. Further, the transmission and reception of signals by the wireless node of operations 1900 may be enabled, for example, by one or more antennas and/or transmitter/receiver unit(s) (e.g., antenna(s) 224 or transmitter/receiver unit(s) 222 of FIG. 2).

The operations 1900 begin, at 1902, where the wireless node obtains a frame comprising a digital signal and an analog signal. At 1904, the wireless node decodes the digital and analog signals and generates reconstructed video frames based on the decoding. At 1906, the wireless node outputs the reconstructed video frames to a video sink device.

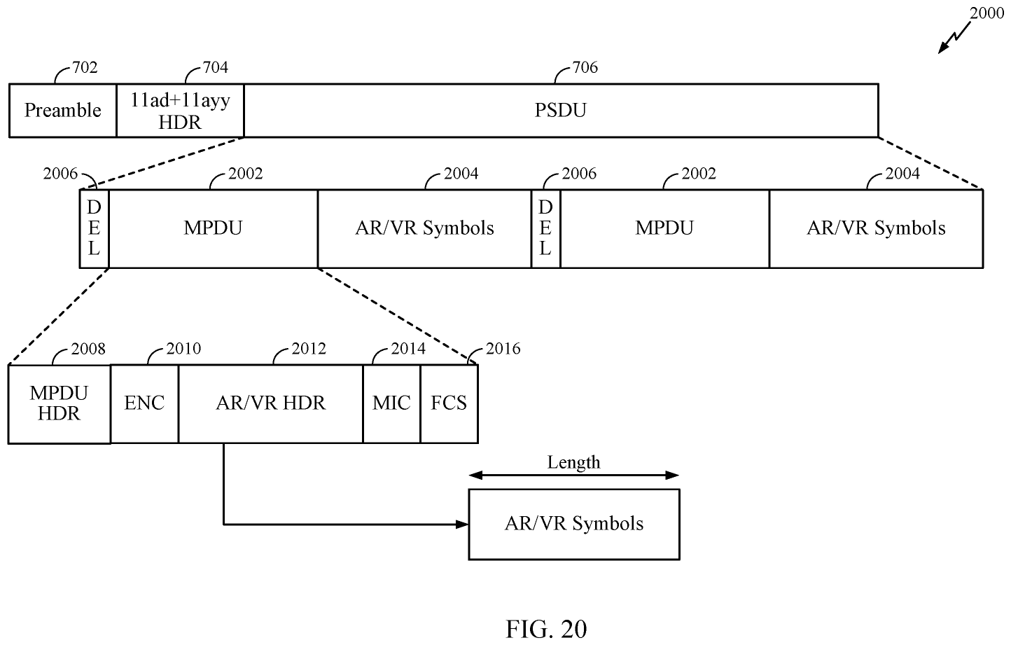

FIG. 20 illustrates an example frame structure for transmitting video data, in accordance with certain aspects of the present disclosure. As shown, the PSDU 706 comprises a MAC PDU (MPDU) 2002, AR/VR analog symbols 2004, which may be separated by delimiters 2006. The MPDU 2002 includes an MPDU header 2008, an encryption indicator 2010, an AR/VR header 2012, a message integrity code (MIC) 2014, and a frame check sequence (FCS) 2016.

The PPDU 2000 may include in the same frame both analog samples and digital samples in an interleaved way. The AR/VR header 2012 may be sent initially within a standard MPDU. The AR/VR header 2012 header may be protected by FCS 2016. The AR/VR header 2012 may include at least one of configuration data, meta-data, control-data, or low rate data associated with the analog symbols, such as a length of the analog symbols, channel allocation of the analog symbols, analog mapping, security signatures, pixel locations, block locations, reliable pixel components, reliable chroma components, sensory data, eye position data, time-stamps, frequency stamps, repetition index, analog coding index, coefficient weights, motion vectors, digitally coded coefficients, run-length encoding output, coefficient scan approach, dithering key, or audio samples. The analog symbols may be separated by an FDE symbol, such as a guard interval or pilot sequences. The receiver may equalize and correct phase and frequency offsets of the analog symbols based on the pilot sequences. The MPDU may indicate a decoding interface of the receiver to be used for decoding the analog symbols. The receiver may decode the digital and analog signals by using the decoding interface indicated in the MPDU. The MPDU 2002 may also include digitally encoded components of the video data (such as the DCs of DCs) as described herein, for example, with respect to the operations illustrated in FIGS. 8 and 11.

The AR/VR analog symbols 2004 may include the transform coefficients determined based on the video compression schemes described herein, for example, with respect to the operations illustrated in FIGS. 8 and 11. For example, the analog symbols 2004 may be the ACs and the ACs of the DCs.

Following the analog symbols 2004, MAC delimiters 2006 may arranged between additional MPDUs. The subsequent MPDUs 2002 may include, for example sensory data, additional AR/VR header, eye position data. For certain aspects, additional analog symbols 2004 may also be attached. The MPDU 2002 may also indicate the additional MAC interface (AR/VR-IF) for decoding the AR/VR symbols.

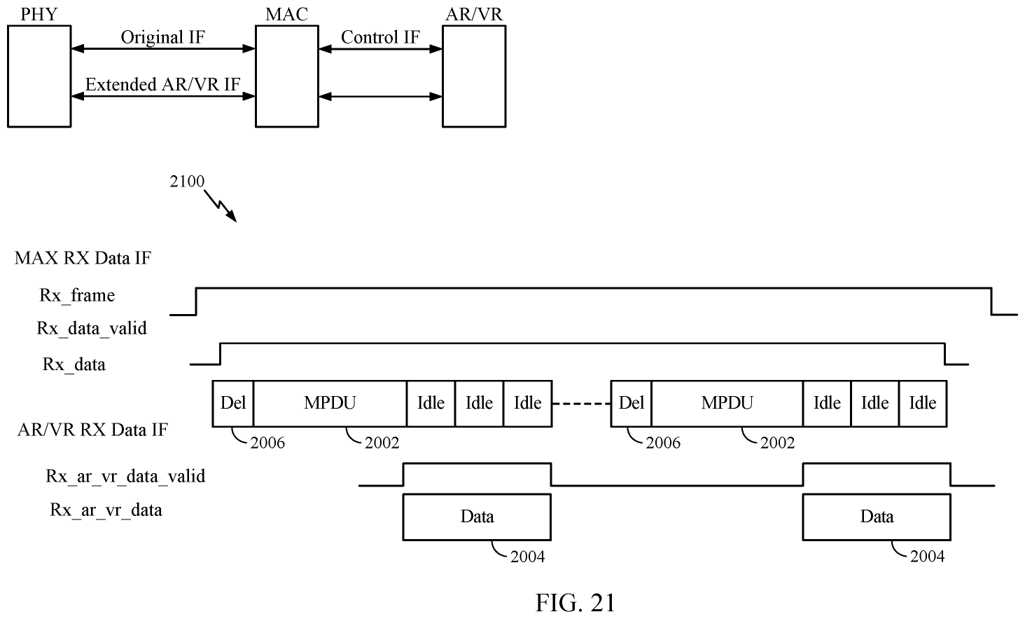

FIG. 21 is an example timing diagram 2100 of a video data transmission via a PDU, in accordance with certain aspects of the present disclosure. As shown, the analog symbols 2004 are interleaved between the digital symbols (MPDU 2002 and delimiters 2006). That is, the analog signal for transmission is output by interleaving portions of the analog signal between portions of the digital signal.

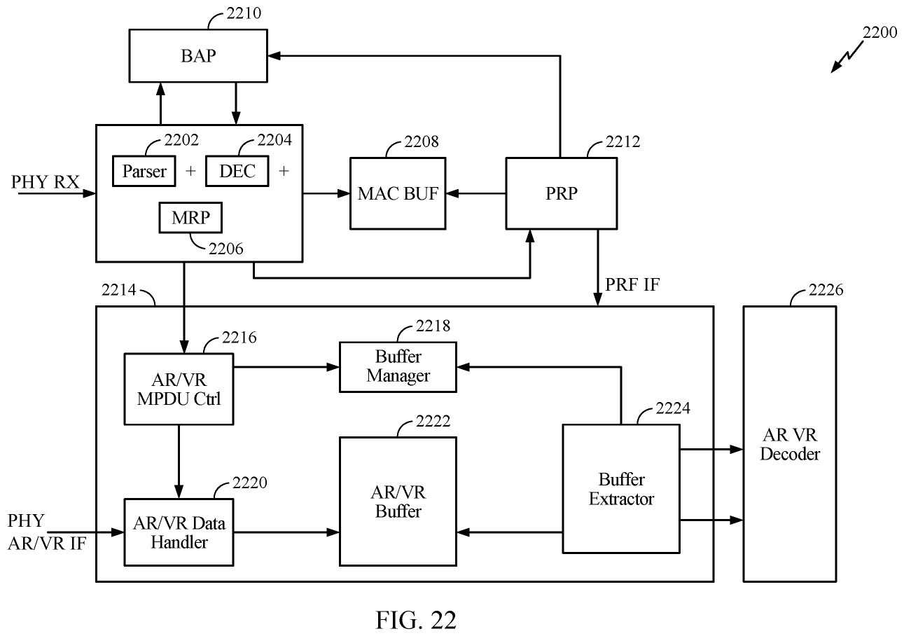

FIG. 22 is a diagram illustrating an example operation 2200 for video frame decoding, in accordance with certain aspects of the present disclosure. As illustrated, a PHY interface forwards the PPDU to the parser 2202, which looks for delimiters and parses the MAC header. The parser 2202 forwards the MPDU to the decryptor 2204, which decrypts the MPDU and passes the data to the MAC Receive Processor (MRP) 2206. The MRP 2206 sends the data to the MAC buffer 2208 and decodes the VR/AR header fields. At the end of the MPDU reception, the parser 2202 updates a Block Ack Processor (BAP) data structure 2210. The BAP 2210 indicates to the MRP whether to discard or store the MDPU. For example, if there is an FCS error or a duplicate MPDU, the MPDU will be discarded. The MRP 2206 sends an indication to AR/VR interface 2214 at the end of the MPDU reception whether to store or discard the AR/VR fields. The AR/VR MAC interface 2214 may also allocate a buffer to store the AR/VR symbols based on this indication. In certain aspects, the MRP 2206 provides the indication to the MPDU Control module 2216. The MDPU Control module 2216 may allocate a buffer for the analog symbol reception by creating a buffer manager 2218.

The PHY interface sends the AR/VR symbols to the AR/VR MAC interface 2214, which stores the symbols in an AR/VR buffer 2222. The PAL Receive Processor (PRP) 2212 reads the MPDU from the buffer and sends an indication to the AR/VR MAC interface 2214 to begin the frame consumption of the analog symbols. The AR/VR MAC interface 2214 forwards the buffer to the AR/VR decoder 2226 for processing. When the AR/VR buffer can be released, the AR/VR MAC interface indicates this to the PRP 2212, which updates the BAP 2210 to release the MPDU.

The MPDU Control module 2216 sends the buffer pointer to the AR/VR data handler 2220. The data handler 2220 receives the analog symbols from the PHY interface and sends the symbols to the AR/VR buffer 2222. For aspects, the PRP 2212 may request for the buffer to be released by sending an indication to the buffer extractor 2224. The buffer extractor 2224 sends the data to the AR/VR decoder 2226. The decoder 2226 decodes the analog symbols and sends the reconstructed video frames to a video sink device (412).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 500, 600, 1400, 1500, 1600, 1700, 1800, and 1900 illustrated in FIGS. 5, 6, 14, 15, 16, 17, 18, and 19 correspond to means 500A, 600A, 1400A, 1500A, 1600A, 1700A, 1800A, and 1900A illustrated in FIGS. 5A, 6A, 14A, 15A, 16A, 17A, 18A, and 19A.

Means for obtaining may comprise an interface to obtain a frame received from another device. Means for outputting may comprise an interface to output a frame for transmission to another device. For instance, in some cases, rather than actually transmitting a frame a device may have an interface to output a frame for transmission (a means for outputting). For example, a processor (the TX data processor 210, the TX spatial processor 220, and/or the controller 230 of the access point 110 or the TX data processor 288, the TX spatial processor 290, and/or the controller 280 of the user terminal 120 illustrated in FIG. 2) may output (or transmit) a frame, via a bus interface, to a radio frequency (RF) front end for transmission. Similarly, rather than actually receiving a frame, a device may have an interface to obtain a frame received from another device (a means for obtaining). For example, a processor (RX data processor 242, RX spatial processor 240, and/or the controller 230 of the access point 110 or the RX data processor 270, RX spatial processor 260, and/or the controller 280 of the user terminal 120 illustrated in FIG. 2) may obtain (or receive) a frame, via a bus interface, from an RF front end for reception.

Means for transforming, means for encoding, means for digitally encoding, means for generating, means for dividing video frames, means for determining, means for applying an analog coding scheme, means for applying a transform, means for applying dithering, means for using a pseudo-random sequence, means for decoding, means for equalizing, or means for correcting phase and frequency offsets may comprise a processing system, which may include one or more processors, such as the RX data processor 242, the TX data processor 210, the TX spatial processor 220, RX spatial processor 240, and/or the controller 230 of the access point 110 or the RX data processor 270, the TX data processor 288, the TX spatial processor 290, RX spatial processor 260, and/or the controller 280 of the user terminal 120 illustrated in FIG. 2.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. The techniques described herein may be utilized in any type of applied to Single Carrier (SC) and SC-MIMO systems.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem (such as an AR/VR console and headset). Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
a first interface configured to obtain one or more video frames;
a processing system configured to:
transform the one or more video frames into first components and second components;
digitally encode the second components; and
generate one or more frames comprising the first components and the digitally encoded second components; and
a second interface configured to output the one or more frames for transmission to a wireless node.

2. The apparatus of claim 1, wherein:
the processing system is further configured to transform the one or more video frames, without rate control feedback from the wireless node, based on multi-stage transforms by at least in part:
dividing each of the one or more video frames into a plurality of blocks,
applying a first transform to each of the blocks to generate first transformed components, and
applying a second transform to at least one of the first transformed components to generate at least one second transformed component;
the first components comprise at least one of the first transformed components; and
the second components comprise the at least one second transformed component.

3. The apparatus of claim 1, wherein the second interface is configured to output the one or more frames for transmission by outputting the first components as analog symbols for transmission via a single carrier.

4. The apparatus of claim 1, wherein:
the processing system is further configured to determine one or more channel-usage allocations for a first portion of at least one of the first components or the second components based on at least one of weights or a histogram of the one or more video frames; and
the second interface is configured to output an indication of the determined one or more channel-usage allocations for transmission and output the one or more frames according to the channel-usage allocation.

5. The apparatus of claim 4, wherein:
the determination of the one or more channel-usage allocations comprises determining that no channel-usage allocations are to be allocated to a second portion of at least one of the first components or the second components based on at least one of the weights or the histogram of the one or more video frames; or
the determination of the one or more channel-usage allocations is based on at least one of weights identified in the histogram, a transmit power of an antenna at the wireless node, an image quality at the wireless node, luma components of the histogram, or chroma components of the histogram.

6. The apparatus of claim 4, wherein the processing system is configured to:
generate the one or more frames by generating multiple repetitions of a third portion of at least one of the first components or the second components based on the one or more channel-usage allocations, or
apply an analog coding scheme to the first components via non-linear iterative mapping based on the one or more channel-usage allocations.

7. The apparatus of claim 1, wherein:
the processing system is further configured to determine one or more channel-usage allocations for the one or more frames based on a point of interest corresponding to the one or more video frames;
the second interface is configured to output an indication of the one or more channel-usage allocations for transmission and output the one or more frames according to the channel-usage allocation.

8. The apparatus of claim 7, wherein the first interface is further configured to obtain a point of interest from a video source of the one or more video frames.

9. The apparatus of claim 1, wherein:
the processing system is further configured to determine motion vectors of the one or more video frames based on a motion of objects represented by the one or more video frames and encode the motion vectors; and
the second interface is configured to output the encoded motion vectors for transmission.

10. The apparatus of claim 1, wherein:
the processing system is further configured to:
generate one or more predictive frames corresponding to an eye of a user based on a portion of the one or more video frames corresponding to another eye of the user,
generate difference information indicative of a difference between the one or more predictive frames and the one or more video frames,
determine one or more first channel-usage allocations for the first and second components and one or more second channel-usage allocations for the difference information, wherein the one or more first channel-usage allocations are different than the one or more second channel-usage allocations, and
apply a transform to the difference information to generate transformed components of the difference information;
the one or more frames comprises an indication of the difference information;
the indication of the difference information comprises the transformed components of the difference information; and the second interface is configured to output an indication of the one or more first channel-usage allocations and the one or more second channel-usage allocations.

11. The apparatus of claim 1, wherein:
the processing system is further configured to:
generate one or more predictive frames corresponding to a focal plane of a user based on a portion of the one or more video frames corresponding to another focal plane of the user; and
generate difference information indicative of a difference between the one or more predictive frames and the one or more video frames; and
the one or more frames comprises an indication of the difference information.

12. The apparatus of claim 1, wherein the second interface is configured to output the one or more frames for transmission by outputting one or more portions of the first components between pilot sequences.

13. The apparatus of claim 1, wherein:
the processing system is configured to transform the one or more video frames by at least in part applying dithering and using a pseudo-random sequence to generate the first components of the one or more frames.

14. An apparatus for wireless communications, comprising:
a processing system configured to generate a frame including transformed components of one or more video frames; and
an interface configured to output the frame for transmission to a wireless node, wherein outputting the frame for transmission comprises outputting a digital signal indicative of a first portion of the frame and an analog signal indicative of a second portion of the frame.

15. The apparatus of claim 14, wherein:
the frame comprises at least one medium access control (MAC) protocol data unit (MPDU) and at least a portion of the transformed components as analog symbols;
the first portion of the frame comprises the at least one MPDU and the second portion of the frame comprises the analog symbols; and
the at least one MPDU comprises at least one header having at least one of configuration data, meta-data, control-data, or low rate data associated with the analog symbols.

16. The apparatus of claim 15, wherein the at least one MPDU indicates a decoding interface of the wireless node to be used for decoding the analog symbols.

17. The apparatus of claim 15, wherein the at least one MPDU comprises a plurality of MPDUs, and wherein the frame includes one or more MAC delimiters between two MPDUs of the plurality of MPDUs.

18. The apparatus of claim 14, wherein:
the interface is configured to output the analog signal for transmission by interleaving portions of the analog signal between portions of the digital signal; and
the frame comprises a physical layer header of a protocol data unit.

19. An apparatus for wireless communications, comprising:
a first interface configured to obtain one or more frames comprising transformed components of one or more video frames, wherein the transformed components comprise digitally encoded symbols and analog symbols;
a processing system configured to decode the transformed components and generate reconstructed video frames based on the decoding; and
a second interface configured to output the reconstructed video frames to a video sink device.

20. The apparatus of claim 19, wherein the processing system is configured to decode the transformed components based on multi-stage inverse transforms.

21. The apparatus of claim 19, wherein the one or frames comprises a header having a channel-usage allocation for the analog symbols, and the first interface is configured to obtain the analog symbols based on the channel-usage allocation of the header.

22. The apparatus of claim 19, wherein the first interface is configured to obtain the one or more frames according to a channel-usage allocation.

23. The apparatus of claim 19, wherein the processing system is configured to generate the one or more frames via a successive refinement operation performed based on at least two previous frame transmissions using different channel-usage allocations.

24. The apparatus of claim 19, wherein the processing system is configured to decode the transformed components based on one or more motion vectors included in the one or more frames.

25. The apparatus of claim 19, wherein the transformed components comprise difference information indicative of a difference between one or more predictive frames and the one or more video frames, the one or more predictive frames corresponding to an eye of a user based on a portion of the one or more video frames corresponding to another eye of the user.

26. The apparatus of claim 19, wherein:
the first interface is configured to obtain the analog symbols between pilot sequences; and
the processing system is configured to equalize and correct phase and frequency offsets of the analog symbols based on the pilot sequences.

27. An apparatus for wireless communications, comprising:
a first interface configured to obtain a frame comprising a digital signal and an analog signal;
a processing system configured to decode the digital and analog signals and generate a reconstructed video frame based on the decoding; and
a second interface configured to output the reconstructed video frame to a video sink device.

28. The apparatus of claim 27, wherein:
the frame comprises at least one medium access control (MAC) protocol data unit (MPDU) and analog symbols;
the digital signal comprises the at least one MPDU and the analog signal comprises the analog symbols; and
the at least one MPDU comprises at least one header having at least one of configuration data, meta-data, control-data, or low rate data associated with the analog symbols.

29. The apparatus of claim 28, wherein the processing system is configured to decode digital and analog signals by using a decoding interface indicated in the at least one MPDU.

30. The apparatus of claim 28, wherein the at least one MPDU comprises a plurality of MPDUs, and wherein the frame includes one or more MAC delimiters between MPDUs of the plurality of MPDUs.

31. The apparatus of claim 27, wherein:
one or more portions of the analog signal are interleaved between portions of the digital signal; and
the frame comprises a physical layer header of a protocol data unit.

32. The apparatus of claim 27, wherein:
the processing system is further configured to determine synchronization information based on a time at which the frame is obtained; and
the decoding of the digital and analog signals is based on the synchronization information.
